(19) United States
(12) Patent Application Publication
(10) Pub. No.: US 2023/0399474 A1
(43) Pub. Date: Dec. 14, 2023

(54) PROCESS FOR MAKING SILICONE RUBBER BASE COMPOSITIONS

(71) Applicant: DOW SILICONES CORPORATION, Midland, MI (US)

(72) Inventors: Kalyn FROESCHLE, Midland, MI (US); Jens NATTERODT, Wiesbaden (DE); Rainer FREUDENBERGER, Wiesbaden (DE); Thomas PEITZ, Midland, MI (US); Roger ROMAIN, Midland, MI (US); Ruediger SIEBMANN, Wiesbaden (DE)

(21) Appl. No.: 18/035,276

(22) PCT Filed: Nov. 11, 2021
(86) PCT No.: PCT/US2021/058886

§ 371 Date: May 3, 2023

Related U.S. Application Data
(60) Provisional application No. 63/113,220, filed on Nov. 13, 2020.

(51) Int. Cl. C08J 3/20; C08J 3/07; C08J 3/00; C08K 9/00; C08K 3/36

(52) U.S. Cl. CPC C08J 3/20; C08J 3/07; C08J 3/005; C08K 9/00; C08K 3/36; C08J 2319/00

(57) ABSTRACT

A process and apparatus for the continuous preparation of silicone rubber base compositions as well as the resulting compositions produced therefrom. This disclosure aims to cover a new continuous manufacturing process for making silicone rubber base compositions using an in situ silica treatment. The new continuous manufacturing process uses twin-screw extruder (TSE) technology.

The present disclosure relates to a process and apparatus for the continuous preparation of silicone rubber base compositions as well as the resulting compositions produced therefrom. This disclosure aims to cover a new continuous manufacturing process for making silicone rubber base compositions using in-situ silica treatment. The new continuous manufacturing process uses twin-screw Extruder (TSE) technology.

Silicone rubber compositions which are curable by hydrosilylation (otherwise referred to as addition) reactions are typically prepared by initially preparing a silicone rubber base composition by mixing polydiorganosiloxane polymers containing at least two alkenyl (or alkynyl) groups per molecule with reinforcing silica fillers. The reinforcing silica fillers are naturally hydrophilic which renders them difficult to inter-mix with the polydiorganosiloxane polymer(s) and as such said fillers are usually either pre-treated with a treating agent to render them hydrophobic, or alternatively are provided in a hydrophilic form. In the latter case a hydrophobic treating agent is provided to treat the silica in situ during the mixing process, usually in an in-situ silica treatment process, i.e. incorporation and dispersion of silica in polymer is done in presence of a treating agent. The product of this mixing step is a silicone rubber base composition. This may be provided in a form suitable for mixing with other ingredients as discussed below. Alternatively, it may be in the form of a concentrate (often referred to by the industry as a “masterbatch” (MB)) which is typically diluted with further polydiorganosiloxane polymer(s) before use.

Once the silicone rubber base composition has been prepared, organohydrogen polysiloxanes and hydrosilylation catalyst(s) may be added to the base, once prepared, in order to cure the composition. However, usually commercial compositions are produced in multiple parts, typically in two-parts, to prevent premature cure in storage prior to use. In such two-part compositions, one part, often referred to as part A, comprises the pre-prepared base and a hydrosilylation catalyst and the second part, often referred to as part B, comprises pre-prepared base and one or more organohydrogen polysiloxane cross-linker(s). Optionally one or more cure inhibitors may be added to the part A composition, the part B composition or both the part A and the part B compositions. Preferably both parts (A and B) are pumpable liquids, typically prepared using the pre-prepared base having a standard formulation with up to e.g. 30% silica and the remainder largely being liquid polydiorganosiloxanes containing at least two alkenyl groups per molecule.

A variety of treating agents may be utilised to render the filler hydrophobic. One commonly used treating agent for in situ treatment of silica fillers in silicone rubber base compositions is hexamethyldisilazane (HMDZ), which initially hydrolyses and then the hydrolysed product reacts with OH—groups on the silica filler surface resulting in a reduced number of free OH— groups on the silica and as such rendering the silica surface increasingly hydrophobic.

Whilst continuous methods for preparing silicone rubber base compositions are known, silicone rubber base compositions are more often still produced using a wide variety of batch methods. These may include
(i) Batch mixing and/or kneading one or more liquid polydiorganosiloxanes containing at least two alkenyl groups per molecule and hydrophobically pre-treated reinforcing silica fillers; and
(ii) Batch mixing and/or kneading one or more liquid polydiorganosiloxanes containing at least two alkenyl groups per molecule and untreated reinforcing silica fillers with a hydrophobic treating agent to treat the silica in situ during the mixing process.

In both instances, the mixing process usually takes place in a suitable mixer and/or kneader such as a planetary type mixer, a Banbury mixer, a change can mixer, a dissolver mixer or a sigma blade kneader or the like. Batch processes are inefficient and have a plethora of issues. They are expensive to run, because of high labor intensity and energy consumption, due to long mixing times (e.g. from 4 to 12 hours per batch) and the need to use inert gas because of the risk of formation of explosive mixtures. Furthermore, the required machinery is increasingly large and heavy as the required mixing energy for filler dispersion increases with batch size which may consequently limit scalability. They are known to mix inconsistently giving both variable physical properties between batches and/or with non-homogeneous shear can result in non-uniform size distribution of filler that results in variations in properties. Furthermore, after mixing, the silicone rubber base compositions need to be stripped of volatiles and cooled which requires additional time and causes delays before the next batch can be introduced. Hence, in summary batch processes for making silicone rubber base compositions are expensive for labour, energy and capital reasons and may be inconsistent from a quality perspective.

A variety of continuous processes have been proposed for the preparation of silicone rubber base compositions by way of continuous processes. For example, compounding processes may take place in a twin-screw extruder via continuous and simultaneous feed of an organopolysiloxane bearing vinyl groups, of a filler, and also of a liquid polysilazane, and water; using a biaxial system of continuous extrusion.

In general in situ processes have the disadvantage of high emissions (problem of exhaust gas) which occur on all kneading machines and are difficult to control. Another factor with continuous in-situ processes is that there are only limited opportunities for targeted control of the hydrophobing process, and a relatively high level of product quality variation can therefore be observed, especially in the case of short residence time for filler treating steps. Another disadvantage of previous in-situ processes derives from the ever-present risk that explosive mixtures will be formed.

The majority of continuous processes thus far proposed tend to utilise pre-treated fillers as it has proven difficult to incorporate satisfactory in-situ filler treatment steps in such continuous processes. However, pre-treated fillers are an expensive commodity and their use in the manufacture of silicone rubber bases and subsequent compositions can result in the bases and compositions being economically unviable. Furthermore, silicone base compositions produced continuously, using fillers pre-treated with a hydrophobic coating, have been found to have stability problems when compared with silicone compositions comprising silicone rubber base compositions produced batchwise. Reasons for this include the comparatively low residence time of the organopolysiloxane and filler in continuous processes for the production of silicone rubber base compositions. Low residence times in continuous processes often lead to
(i) incomplete breakdown of filler agglomerates of the, resulting in silicone elastomer inhomogeneity and/or poor transparency; and
(ii) incomplete in situ hydrophobing of silica fillers resulting in said fillers having larger numbers of residual OH—groups on the filler surface and consequently the filler remains significantly more hydrophilic than desired.

This directly leads to high viscosity or to reduced stability. The reduced stability of silicone compositions can become apparent, for example, again as an increase in the viscosity of the silicone compositions after storage, and this occurs particularly at elevated temperatures. Furthermore, given organohydropolysiloxanes are used as crosslinking agents in the finished silicone compositions, an increased level of degradation of silicon bonded hydrogen (Si—H) groups can be observed, with evolution of hydrogen. This is compounded by a considerable risk of explosion when oxygen is present. An associated change in the architecture of the network also creates the risk of altering the property profile of the silicone elastomers obtained after the vulcanization process. In self-adhesive silicone compositions, another possible result of an inadequately deactivated surface of the filler is undesired reactions of reactive groups at the surface of the filler with additives such as adhesion promoters, inevitably leading to impairment of adhesion properties or at least unwanted significant increases in viscosity.

Previous continuous processes involving in situ treatment of fillers devote larger volume mixing compartments during the process or at the end of the process flow that broaden residence time, which leads to homogenization of larger volumes to overcome short term inconsistencies. This significantly complicates changeover.

Manufacturers are continually seeking improved processes to increase process efficiency, minimise waste of time, capital, labour intensity and materials, and to allow for greater flexibility in the type and amounts of ingredients and additives in the silicone rubber base compositions.

There is a desire to have a continuous method for preparing silicone rubber base compositions including the in situ treatment of fillers at a high productivity while obviating previous drawbacks.

There is provided herein a continuous method for the preparation of a silicone rubber base composition comprising
(i) one or more polyorganosiloxanes containing at least two unsaturated groups per molecule selected from alkenyl groups and alkynyl groups (A) and
(ii) a hydrophobically treated reinforcing silica filler (B); comprising the steps of
   (a) introducing at least one hydrophobing treating agent (C), the one or more polyorganosiloxanes containing at least two unsaturated groups per molecule selected from alkenyl groups and alkynyl groups (A), and optionally water (D) into a first static mixer to form a step (a) mixture and then introducing said step (a) mixture on to a first twin-screw extruder;
   (b) introducing reinforcing silica filler (B) into said step (a) mixture via a reinforcing silica filler (B) entry port in the first twin-screw extruder while maintaining the temperature in a range of between 20 to 80° C. or even up to 90° C. to form a viscous paste and providing at least one vent to the atmosphere upstream or downstream of the reinforcing silica filler (B) entry port to allow gases present to escape;
(c) mixing the viscous paste resulting from step (b) in a dispersive mixing and kneading zone in the first twin-screw extruder to form a silica dispersion;
   (d) further mixing the silica dispersion produced in step (c) residence zone downstream of said first twin-screw extruder to provide an unstripped silicone rubber base composition;
(e) stripping the unstripped silicone rubber base composition with a means for vacuum stripping to provide a silicone rubber base composition at a temperature of at least 100° C.; and
(f) introducing component (C) and optionally one or both of components (A) and (D) either into said first twin-screw extruder between steps (c) and (d) and/or during step (d) to dilute and further hydrophobically treat silica from the silica dispersion of step (c) and subsequently form a diluted silica dispersion.

There is also provided a silicone rubber base composition manufacturing assembly adapted to make a silicone rubber base composition by means of the process as described herein.

There is also provided a silicone rubber base composition obtainable or obtained by means of the process as described herein and articles made therefrom.

There is also provided the use of a silicone rubber base composition as prepared herein in the preparation of a hydrosilylation cure silicone rubber composition.

It is to be understood that the term mixing as used herein means the function of mixing effected by the kneader/extruder, which might also be referred to as milling or any other appropriate term used in the industry.

It was found that the continuous process herein can produce base compositions which are sufficiently well mixed to match standard batch mixed compositions but which do not require complicated silica filler pre-treatment steps and/or high temperature/high pressure processing in order to produce good quality silicone rubber base compositions at reduced cost.

As discussed above, the present process does not require a pre-wetting step for treating the silica filler with components (A) and/or (C) in a static mixer or batch mixer prior to introduction onto the twin screw extruder. Historically it seems to have been deemed essential in some continuous processes to “pre-condition” the silica by densifying (increasing the density) to ease the feeding of the silica into the extruder. This was advantageously seen to be unnecessary for the present process cutting out a time-consuming step and the mixing was satisfactory in the twin-screw extruder as hereinbefore described.

Furthermore, it will be appreciated that the twin screw extruder utilised herein is intentionally not a closed system running at high temperature and pressure which is so designed to ensure the treating agent, which is typically volatile, is retained in the first twin screw extruder. The fact that the twin screw extruder contains vents herein is another reason for not requiring silica pre-treatment prior to entry on the twin screw extruder as gases introduced into the first twin screw extruder during the introduction of the untreated silica filler may be released through the vents upstream of the silica treating zone of our process. In the case of previously un-vented processes with no vent upstream of the treatment section of the process, the gas must either dissolve or travel against the silica stream, which limits the silica feed rate.

The avoidance of high temperatures and pressures on the first twin screw extruder in the present process avoids the need for a stripping zone in the first twin screw extruder. It was considered that an improved quality of silica treatment was achieved by introducing steps (d) and (e) after exit from the first screw extruder, thus also avoiding short silica treatment residence times and by introducing a post twin screw extruder residence zone it is believed far more consistently treated filler is obtained.

The main components to be mixed in the current process are the one or more polyorganosiloxanes containing at least two unsaturated groups selected from alkenyl groups and alkynyl groups (A);
reinforcing silica filler (B);
a hydrophobing treating agent, (C); and optionally water (D).
   A) One or More Polyorganosiloxanes Containing at Least Two Unsaturated Groups Per Molecule Selected from Alkenyl Groups and Alkynyl Groups

The one or more polyorganosiloxanes containing at least two unsaturated groups per molecule selected from alkenyl groups and alkynyl groups (A) as described above has multiple units of the formula (I):

RₐSiO_{(4-a)/2} (I)

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups (excluding fluoro containing groups) such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. The subscript “a” is 0, 1, 2 or 3.

Siloxy units may be described by a shorthand (abbreviated) nomenclature, namely—“M,” “D,” “T,” and “Q”, when R is a methyl group (further teaching on silicone nomenclature may be found in Walter Noll, Chemistry and Technology of Silicones, dated 1962, Chapter I, pages 1-9). The M unit corresponds to a siloxy unit where a=3, that is R₃SiO_{1/2}; the D unit corresponds to a siloxy unit where a=2, namely R₂SiO_{2/2}; the T unit corresponds to a siloxy unit where a=1, namely R₁SiO_{3/2}; the Q unit corresponds to a siloxy unit where a=0, namely SiO_{4/2}.

Examples of typical groups on the one or more polyorganosiloxanes containing at least two unsaturated groups per molecule selected from alkenyl groups and alkynyl groups (A) include mainly alkenyl, alkyl, and/or aryl groups. The groups may be in pendent position (on a D or T siloxy unit) or may be terminal (on an M siloxy unit).

The silicon-bonded organic groups attached to component (A) other than alkenyl groups and/or alkynyl groups are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with the groups that do not interfere with curing of this inventive composition, such as halogen atoms. Preferred species of the silicon-bonded organic groups are, for example, alkyl groups such as methyl, ethyl, and propyl; and aryl groups such as phenyl.

Examples of component (A) are polydiorganosiloxanes containing alkenyl or alkynyl groups but typically alkenyl groups at the two terminals and are represented by the general formula (II): R′R″R′″SiO—(R″R″′SiO)ₘSiOR″′R″R′ (I)

In formula (I), each R′ is an alkenyl or alkynyl group but typically an alkenyl group, which typically contains from 2 to 10 carbon atoms, such as vinyl, allyl, and 5-hexenyl.

R″ does not contain ethylenic unsaturation. Each R″ may be the same or different and is individually selected from monovalent saturated hydrocarbon radical, which typically contain from 1 to 10 carbon atoms, and monovalent aromatic hydrocarbon radical, which typically contain from 6 to 12 carbon atoms. R″ may be unsubstituted or substituted with one or more groups that do not interfere with curing of this inventive composition, such as halogen atoms. R′″ is R′ or R″ and m represents a degree of polymerization suitable for component (A) to have a viscosity within the range discussed below.

Typically, all R″ and R′″ groups contained in a compound in accordance with formula (I) are methyl groups. Alternatively, at least one R″ and/or R′″ group in a compound in accordance with formula (I) is methyl and the others are phenyl or 3,3,3-trifluoropropyl. This preference is based on the availability of the reactants typically used to prepare the polydiorganosiloxanes (component (A)) and the desired properties for the cured elastomer prepared from compositions comprising such polydiorganosiloxanes.

Each polyorganosiloxane containing at least two unsaturated groups per molecule selected from alkenyl groups and alkynyl groups (A) is preferably a polydiorganosiloxane containing at least two unsaturated groups per molecule selected from alkenyl groups and alkynyl groups. When (A) is one or more polydiorganosiloxanes, each polydiorganosiloxane may be selected from polydimethylsiloxanes, alkylmethylpolysiloxanes, alkylarylpolysiloxanes or copolymers thereof (where reference to alkyl means an alkyl group having two or more carbons) containing e.g. alkenyl and/or alkynyl groups and may have any suitable terminal groups, for example, they may be trialkyl terminated, alkenyldialkyl terminated alkynyldialkyl terminated or may be terminated with any other suitable terminal group combination providing each polymer contains at least two unsaturated groups per molecule selected from alkenyl and alkynyl groups. Hence when (A) is one or more polydiorganosiloxanes containing at least two unsaturated groups per molecule selected from alkenyl groups and alkynyl groups, (A) may be, for the sake of example, dimethylvinyl terminated polydimethylsiloxane, dimethylvinylsiloxy-terminated dimethylmethylphenylsiloxane, trialkyl terminated dimethylmethylvinyl polysiloxane or dialkylvinyl terminated dimethylmethylvinyl polysiloxane copolymers.

The molecular structure of each polyorganosiloxane of component (A) is typically linear, e.g. a polydiorganosiloxane, however, there can be some branching due to the presence of T units (as previously described) within the molecule, In one embodiment component (A) may partially comprise a polyorganosiloxane resin containing at least two unsaturated groups selected from alkenyl groups and alkynyl groups. In such cases the polyorganosiloxane resin may be a DT resin, an MT resin, an MDT resin, a DTQ resin, an MTQ resin, an MDTQ resin, a DQ resin, an MQ resin, a DTQ resin, an MTQ resin, or an MDQ resin. Hence, component (A) may comprise one or more polydiorganosiloxanes containing at least two alkenyl groups per molecule and optionally a polyorganosiloxane resin containing at least two alkenyl groups per molecule.

Component (A), the one or more polyorganosiloxanes containing at least two unsaturated groups per molecule selected from alkenyl groups and alkynyl groups, is present in the base composition in an amount of from 60 to 90 wt. % of the composition.

The viscosity of each polyorganosiloxane containing at least two unsaturated groups per molecule selected from alkenyl groups and alkynyl groups (A) may be between from 250 mPa·s to 750,000 mPa·s, alternatively 400 mPa·s to 500,000 mPa·s, alternatively 400 mPa·s to 250,000 mPa·s using a TA-Instruments AR2000Ex cone plate rheometer @ 10 s⁻¹ for viscosities of 1000 mPa·s and above or a Brookfield ° rotational viscometer with spindle LV-1 (designed for viscosities in the range between 15-20,000 mPa·s) for viscosities less than 1000 mPa·s and adapting the shear rate according to the polymer viscosity e.g. 10 s⁻¹ or 100 s⁻¹. Unless otherwise indicated, all viscosity measurements were taken at 25° C.

### (B) Reinforcing Filler

The silicone rubber base as hereinbefore described contains a reinforcing filler, i.e. a reinforcing silica filler such as finely divided silica such as precipitated silica, fumed silica and/or colloidal silica. The silica chosen typically has a relatively high specific surface area, which is typically at least 50 m²/g (using a suitable BET method e.g. in accordance with ISO 9277: 2010). Fillers having specific surface areas of from 100 to 450 m²/g (BET method, e.g. in accordance with ISO 9277: 2010), alternatively of from 100 to 350 m²/g (BET method, e.g. in accordance with ISO 9277: 2010), are typically used.

The reinforcing silica filler B may be of any suitable form providing that it is a fine powder capable of reinforcing silicone rubber. Typical examples of such fillers include dry process silicas, such as fumed silica and wet process silicas, such as precipitated silica. The specific surface area of the reinforcing silica filler is preferably 50 m²/g or greater.

The amount of finely divided silica or other reinforcing filler used in the silicone rubber base composition described herein is at least in part determined by the physical properties desired in the end product into which the base is included, e.g. the cured elastomer prepared using the base composition herein. The present process allows for an amount of reinforcing filler in the silicone rubber base composition from 10 to 40 wt. %, alternatively from 10 to 35 wt. %, alternatively from to 35 wt. % of the base composition as required dependent on the intended end use.

### (C) Hydrophobing Treating Agent

Untreated silica fillers are naturally hydrophilic and are typically treated with a treating agent when being used as reinforcing fillers for silicone compositions. Whilst the fillers may be treated prior to mixing with polydiorganosiloxane polymers to form a base composition, increasingly a hydrophobing treating agent (C) is used to treat the filler in situ (i.e. in the presence of at least a portion of the other components of the base composition e.g. some but not necessarily all of component (A) described above by mixing these components together until the filler is completely treated and uniformly dispersed to for a homogeneous material).

The hydrophobing agent participates in a condensation reaction with the silanol groups on the surface of component B. making it easier for this component to mix with component A. It is possible to use a wide range of materials as the treating agents. Whilst materials such as a fatty acid or a fatty acid ester such as a stearate may be used, in the case of silicone rubber base compositions the filler treating agent can be any low molecular weight organosilicon compounds disclosed in the art applicable to prevent creping of organosiloxane compositions during processing. These are typically chosen from organosilanes, polydiorganosiloxanes, organosilazanes or short chain siloxane diols or mixtures thereof are used. The treating process renders the filler(s) hydrophobic and therefore easier to handle and obtain a homogeneous mixture with the other ingredients. The surface treatment of the fillers makes the fillers easily wetted by the silicone polymer. These surface modified fillers do not clump and can be homogeneously incorporated into the silicone polymer. This results in improved room temperature mechanical properties of the uncured compositions.

The agent adapted to hydrophobe the silica filler or hydrophobing agent (component C) renders component B hydrophobic and makes the reinforcing silica filler easier to mix with component A. The hydrophobing agent should preferably be an organosilicon compound containing silanol groups or hydrolyzable groups attached to silicon atoms.

The treating agents are exemplified but not limited to liquid hydroxyl-terminated polydiorganosiloxane containing an average from 2 to 20 repeating units of diorganosiloxane in each molecule, hexaorganodisiloxane, hexaorganodisilazane, e.g. hexamethyldisilazane (HMDZ) and the like. The hexaorganodisilazane tends to hydrolyse under conditions used to treat the filler to form the organosilicon compounds with hydroxyl groups. Typically, at least a portion of the silicon-bonded hydrocarbon groups present in the treating agent are identical to a majority of the hydrocarbon groups present in components (A) and (B).

It is believed that the treating agents function by reacting with silicon-bonded hydroxyl groups present on the surface of the silica or other filler particles to reduce interaction between these particles.

Specific examples of such hydrophobing agents include hexamethyldisilazane, divinyltetramethyldisilazane, and other hexaorganodisilazanes; trimethylsilanol, dihydroxydimethylsiloxane oligomers, or dihydroxymethylphenylsiloxane oligomers, dihydroxymethylvinylsiloxane oligomers, and other organosilane or organosiloxane oligomers having silanol groups; and organosilane or organosiloxane oligomers in which hydrolyzable groups are attached to silicon atoms. Hexamethyldisilazane (HMDZ), divinyltetramethyldisilazane, and other hexaorganodisilazanes are preferred because they exhibit high reactivity in relation to the reinforcing silica filler and have powerful hydrophobing properties. In some cases, if desired, fluorinated hydrophobing agents may be used, such as, for the sake of example, one or more silanol terminated fluorinated siloxane oligomer(s) having from 2 to 20 siloxane units, and/or one or more fluorinated silane diol(s), and/or one or more fluorinated trialkoxy silane(s), and/or one or more fluorinated silazane(s) or a mixture thereof.

Component (C) is added into the base composition in an amount constituting from 1 to 30 wt. % of component (B) the silica filler. This amount varies with the moisture content, specific surface area, and silanol group content of component (B). as well as with the content of silanol groups or hydrolyzable groups attached to silicon atoms in component (C). Mixing components (A) to (C) alone is sufficient for producing a silicone rubber base composition, although chemically inert polyorganosiloxanes, pigments, heat-resistant agents, organopolysiloxane resins containing alkenyl groups, and the like may also be added.

### (D) Water

A small amount of water can be added together with the silica treating agent(s) as processing aid in order to promote hydrolysis and to enhance the treatment effect. This is particularly the case when component (C) is a hexaorganodisilazane such as hexamethyldisilazane (HMDZ).

In step (a) of the continuous method for the preparation of a silicone rubber base composition as hereinbefore described, hydrophobing treating agent (C), water (D) and the one or more polyorganosiloxanes containing at least two unsaturated groups per molecule selected from alkenyl groups and alkynyl groups (A) are each separately introduced into a first static mixer and subsequently on to the first twin-screw extruder to form a step (a) mixture.

Any conventional static mixer may be used as the first static mixer. For the avoidance of doubt, a static mixer is a means of mixing of ingredients flowing through a mixing channel in said mixer without the use of moving parts. The mixing channel typically has a cylindrical or squared cross-section or alternatively may be a plate-type mixer. This mixing is generally achieved by having a plurality of elements configured in series along the channel length and designed to mix, split and re-orientate the flow of material while passing through said channel in order to generate a homogeneous blend of ingredients.

The static mixer may be of any suitable size e.g. the diameter of a cylindrical mixer can vary from about 6 mm to 30 cm, alternatively from about 6 mm to 25 cm, alternatively from about 6 mm to 20 cm, alternatively from about 6 mm to 15 cm, alternatively from about 6 mm to 12.5 cm diameter, if desired. The mixer and mixer components can be made from any suitable materials as required provided they do not chemically interact with any one of components being mixed e.g. for the sake of example, stainless steel, polypropylene, Teflon, polyvinylidene difluoride (PVDF), polyvinyl chloride, chlorinated polyvinyl chloride (CPVC) and polyacetal.

In the process as hereinbefore defined, the mixing is achieved with the components being hydrophobing treating agent (C), diorganopolysiloxane containing at least two unsaturated groups per molecule selected from alkenyl groups and alkynyl groups (A) an water (D) when required. The mixing is designed to be achieved with as little variation in mixture content as possible.

In order to accommodate same, said hydrophobing treating agent (C), water (D) when present and diorganopolysiloxane containing at least two unsaturated groups per molecule selected from alkenyl groups and alkynyl groups (A) are introduced into the first static mixer at pre-defined controlled rates which may be varied relative to each other within a pre-determined range as and when required.

Components (A), (C) and optionally (D) may be introduced into the said first static mixer using any suitable means. In one embodiment each of said Components (A), (C) and (D) may be introduced into the first static mixer using respective pumping systems or the like. The relative amounts of each component may be controlled and dosing may be carried out using any suitable means, for example by volume, by weight loss or by mass flow (Coriolis force) using respective pump means. Any suitable pump means may be used, e.g. for the sake of example, one or more gear pumps, one or more syringe pumps, one or more piston pumps or a mixture of gear pumps, piston pumps and syringe pumps.

Upon leaving the first static mixer the step (a) mixture is introduced into a first twin-screw extruder.

In step (b) of the process during which reinforcing silica filler (B) is introduced into the step (a) mixture via a reinforcing silica filler (B) entry port in the first twin-screw extruder, the reinforcing silica filler (B) is being wetted by the step (a) mixture and is being dispersed therein and as previously indicated this step is undertaken at a relatively low temperature of between 20° C. and 80° C., alternatively between 25° C. and 70° C. in order to minimise the volatilization of the at least one hydrophobing treating agent (C) (but a temperature of up to 90° C. may be used if deemed absolutely necessary, dependent on the selection of hydrophobing treating agent (C)), and enabling the reinforcing silica filler (B) to be rendered sufficiently hydrophobic even when the at least one hydrophobing treating agent (C), is a comparatively easily volatilized compound such as hexamethyldisilazane (HMDZ) or 1,3-divinyltetramethyldisilazane.

In one embodiment herein the first twin-screw extruder is a co-rotating twin-screw extruder, an intermeshing twin-screw extruder or a co-rotating and intermeshing twin-screw extruder which has an elongate barrel which holds the screws. Typically, in a co-rotating twin-screw extruder, there is provided one or more entry ports and a discharge port situated at or adjacent opposite ends of an extruder barrel. Twin-screws are disposed in parallel in the barrel, with typically the end of each screw nearest the entry port connected to a drive unit. The drive unit is adapted to rotate both the screws at the same speed and in the same direction (i.e. they are synchronized). The screws commonly have double or triple threads and are adapted to mix and knead material traveling along the barrel from the entry port to the discharge port.

In the present disclosure the barrel is divided into a plurality, typically at least three zones, alternatively three to fifteen zones. The different zones are provided for the completion of a series of functions along the length of the extruder barrel whilst the components and mixtures thereof are being transported from their respective entry ports to the discharge port.

The first twin-screw extruder preferably has a greater axial length L versus screw diameter D (henceforth referred to as the L/D ratio). The L/D ratio is preferably from 25:1-75:1, alternatively from 25:1 to 65:1, alternatively from 25:1 to 55:1, alternatively from 30:1 to 50:1. It should be understood that the L/D ratio needs to be greater when optional step (f) is taking place on the first twin screw extruder but the L/D ratio may be much less if step (f) is not taking place on the first twin screw extruder The speed of the screws of the first co-rotating twin-screw continuous extruder are predetermined dependent on the system requirements but, solely for the sake of example may be from 200 to 1200 revolutions per minute (rpm) alternatively 350 to 900 rpm).

The first co-rotating twin-screw extruder used herein is preferably commercially available. Suitable examples for the first co-rotating twin-screw extruder may, for the sake of example be sold under the Trade names Mixtron (manufactured by Kobe Steel), TEM (manufactured by Toshiba Machine Co.), Century Extrusion (manufactured by the CPM Extrusion Group) and ZSK (manufactured by Coperion (formerly Werner Pfleiderer)). The screw configuration utilised comprises conveying and mixing zones as described further herein.

The first zone on the twin-screw extruder is provided as a compounding zone for introducing reinforcing filler (B) into the step (a) mixture and thereby wetting the surface of the reinforcing filler (B) with the step (a) mixture to form a viscous paste, whilst maintaining the temperature of the mixture between 20° C. and 80° C. Hence, in the first zone there is provided the entry port for the step (a) mixture described above, containing hydrophobing treating agent (C), the one or more polyorganosiloxanes containing at least two unsaturated groups per molecule selected from alkenyl groups and alkynyl groups (A) and optionally water (D). There is also provided a reinforcing filler (B) entry port and optionally one or more vents to the atmosphere between the entry port for the step (a) mixture and the reinforcing filler (B) entry port and/or one or more vents to the atmosphere upstream of the filler entry port.

Component (B) may be fed to the reinforcing filler (B) entry port at a constant rate with the aid of a suitable continuous feeder for powder in the form of e.g. tables, belts, loss in weight feeders, side feeders with or without vacuum capability, or screws. This is because the reinforcing silica filler is very low density e.g. 50 to 100 g per litre and doesn't self-pack the gases accompanying the reinforcing silica filler into the twin-screw extruder commonly either air or nitrogen, escape through the one or more atmospheric vents positioned upstream and/or downstream, alternatively upstream of the filler (B) entry port. This is preferred because without vents, there would need to be a back flow of the gases to allow the gases to escape e.g. via the reinforcing filler (B) entry port as the extruder compresses the mixture during the formation of the viscous paste. Whilst the twin-screw extruder may be designed to allow for said backflow such situations negatively affect the throughput rates of the components during their residence in the twin-screw extruder.

Step (c) of the process, mixing the viscous paste resulting from step (b) to improve the dispersion of the silica occurs in the second zone, which is a dispersive mixing and kneading zone in which the temperature in this second zone of the barrel is generally from 75° C. to about 150° C., alternatively from 80° C. to 145° C., alternatively from 85° C. to 145° C. to produce a dispersion of reinforcing filler (B) in the other components. The screws in the second zone may comprise combinations of backwards conveying and kneading elements which are utilised to break down the reinforcing silica filler from agglomerates (50-100 μm) to aggregates (1-10 μm) and ultimately considerable fractions of the silica may comprise silica in the 50-500 nanometer range. It has been found that by reducing the particle from agglomerates to aggregates as hereinbefore described leads to improved reinforcement in final cured articles.

Subsequently the resulting dispersion from step (c), may be transferred into an optional third zone, in accordance with step (f) of the process wherein component (C) and optional one or both of components (D) and (A) may be introduced into said first twin-screw extruder between steps (c) and (d), to dilute and further hydrophobically treat silica from the silica dispersion of step (c) and subsequently form a diluted silica dispersion prior to exiting from the first twin screw extruder through the discharge port for step (d). Typically, the temperature of the material exiting the first twin screw extruder through the discharge port will be at a temperature in the range of from 75-150° C., alternatively from 90 to about 130° C.

It was found that introducing vents in the first zone of the twin screw extruder, whilst enabling the removal of gases introduced with the introduction of silica powder, could lead to the loss of some of the component (C) present in the twin screw extruder, especially if volatile but that the introduction of even a small additional amount of component (C) in step (f) overcame this.

When present, the third zone comprises one or more additional entry ports provided for the introduction of additional amounts of component (C) and optionally one or both of component (D) and/or component (A). These may be provided as an individual entry port per component added or may involve entry ports for mixtures of two or more of said component (C), component (D), component (A) or a combination thereof.

Hence, there may be one of the following attached to first twin-screw extruder in said third zone:
(i) one additional entry port for the introduction of a mixture of component (C), optionally mixed with one or both of component (A) and component (D);
(ii) a first additional entry port for the introduction of components (C) and optionally component (D) and a second additional entry port for the introduction of component (A) into the first twin-screw extruder;
(iii) one additional entry port for the introduction of component (A), optionally mixed with component (D);
(iv) three additional entry ports, one for each of component (C), component (D) and component (A).
   Of the above options (i) and (ii) are the more preferred.

When the above involves the introduction of mixtures, the mixtures may be prepared in any suitable manner prior to introduction into the twin-screw extruder. For example, when an additional mixture including component (C) and in addition both component (D) and component (A) or an additional mixture consisting of component (C) and optionally component (D) is being introduced into the first twin-screw extruder via a single entry port, the respective components may be mixed together whilst being transported through a second static mixer which may or may not be the same as the aforementioned first static mixer.

When a second static mixer is utilised for the introduction of a mixture of two or more of components (C), (D) and (A) in the third zone each component being introduced into the second static mixer is done so at pre-defined controlled rates. The controlled rates may be determined by weight loss, volume or by mass flow (Coriolis) relative to each other to ensure the required mixture is introduced onto the first twin screw extruder.

When step (f) takes place in the third zone the silica dispersion of step (c) is diluted to form a diluted silica dispersion before being transported out of the first twin screw extruder through the discharge port to the residence zone where further mixing takes place in accordance with step (d) to provide an unstripped silicone rubber base composition before stripping out of the by-products in step (e). The temperature of the residence zone for mixing step (d) is typically between 90 and 170° C., alternatively from 100-160° C.

Step (f) may alternatively or additionally also occur in an analogous fashion during step (d) in the residence zone positioned between the first twin screw extruder and the means for vacuum stripping.

Irrespective of whether step (f) takes place in the third zone, or in the residence zone, component (A) may be introduced to dilute the composition after step (c) in the first twin screw extruder and/or in the residence zone and/or even on the second twin screw extruder.

The following elements may also be disposed between the starting material entry ports and the discharge port: atmospheric vents for the release of gases and volatile components of the mixture, temperature sensors for measuring the temperature of the mixture, flow rate sensors, pressure sensors, other instrumentation sensors, and the like.

Components fed into the first twin screw extruder may be introduced at any required temperature, for example any mixture resulting from mixing components (A), (C) and (D) in the second static mixer may be introduced into the first twin-screw extruder at room temperature or if desired after heating to a predetermined temperature range.

The external surface of the barrel of the first co-rotating twin-screw extruder may be heated or cooled as desired to ensure the temperature of each zone along the barrel of the first twin screw extruder is maintained within its desired range. For example, in regions where the barrels of the first twin screw extruder generate frictional heat the external surface of the barrel of the twin-screw extruder may be cooled e.g. in a coolant-circulated jacket if desired.

After being mixed in the residence zone between the first twin screw extruder and the means for vacuum stripping in accordance with step (d) and optionally (f) the resulting unstripped silicone rubber base composition is transported to a means for vacuum stripping the resulting unstripped silicone rubber base composition.

The means for vacuum stripping the unstripped silicone rubber base composition may be any suitable continuous stripping device specifically designed to vacuum strip the aforementioned unstripped silicone rubber base composition of step (d) to remove residual treating agent, water, and ammonia, if present under heat and vacuum, in order to produce the silicone rubber base composition. For example, the continuous stripping device may be selected from suitable devolatilizing extruders such as co-rotating twin-screw extruders, counter-rotating non intermeshing twin screw extruder, Multi Rotation Section (MRS) extruders and the like.

In order to achieve the transportation of the unstripped silicone rubber base composition of step (e) to the means for vacuum stripping the unstripped silicone rubber base composition of step (e) may be pumped downstream from the first twin-screw extruder to the means for vacuum stripping by way of any suitable equipment, e.g. by way of said one or more heated pipe sections, hose(s) and/or static mixers or by actively conveying screw heat exchangers a combination thereof using a suitable pumping means e.g. a suitable gear pump using a pressure of between 300 and 2,000 kPa or alternatively by active conveying.

It is to be understood that diluting amounts of component (A) may be introduced into the process as part of step (f) but may also be introduced between the residence zone and the stripping means and/or even after stripping if desired.

If desired, additives may be introduced into the mixture during the preparation i.e. at any suitable juncture in the process up to and including the means for vacuum stripping. These might include colouring agents, and/or ammonium-carbonate, ammonium hydrogen carbonate, and/or more water. Examples of additives include electrically conductive fillers, thermally conductive fillers, non-conductive filler, pot life extenders, flame retardants, lubricants, pigments, colouring agents, silicone polyethers, and mixtures thereof. Further examples of additives include mold release agents, diluents, solvents, UV light stabilizers, bactericides, wetting agent, heat stabilizer, compression set additive, plasticizer, and mixtures thereof. The additives may be added in the form of powders or in the form of liquids.

Examples of electrically conductive fillers include metal particles, metal oxide particles, metal-coated metallic particles (such as silver plated nickel), metal coated non-metallic core particles (such as silver coated talc, or mica or quartz) and a combination thereof. Metal particles may be in the form of powder, flakes or filaments, and mixtures or derivatives thereof.

Examples of thermally conductive fillers include boron nitride, alumina, metal oxides (such as zinc oxide, magnesium oxide, aluminium oxide), graphite, diamond, and mixtures or derivatives thereof.

Examples of non-conductive fillers include quartz powder, diatomaceous earth, talc, clay, alumina, mica, calcium carbonate, magnesium carbonate, hollow glass, glass fibre, hollow resin and plated powder, and mixtures or derivatives thereof.

Examples of flame retardants include aluminium trihydrate, chlorinated paraffins, hexabromocyclododecane, triphenyl phosphate, dimethyl methyl phosphonate, tris(2,3-dibromopropyl) phosphate (brominated tris), and mixtures or derivatives thereof.

Examples of pigments include carbon black, iron oxides, titanium dioxide, chromium oxide, bismuth vanadium oxide and mixtures or derivatives thereof.

Examples of colouring agents include vat dyes, reactive dyes, acid dyes, chrome dyes, disperse dyes, cationic dyes and mixtures thereof.

When or if present, the aforementioned additional ingredients may be present in an amount of from 1 to 30 wt. %, alternatively of from 1 to 20 wt. % of the final silicone rubber base composition.

The temperature of the final silicone rubber base composition upon leaving the means for vacuum stripping may range of from 20 to 230° C., alternatively of from 60 to 210° C., again dependent on the mixing regime utilised.

The final silicone rubber base composition may be prepared in the form of a masterbatch, i.e. in a concentrated form which can be diluted by e.g. the addition of further polymer(s) at a later stage.

The following elements may be disposed between the port for charging the mixture and the discharge port of the second co-rotating twin-screw continuous kneader/extruder: vents to enable release of any volatiles in of the mixture, temperature sensors for measuring the temperature of the mixture, pressure sensors, other instrumentation sensors, and the like.

The second co-rotating twin-screw continuous kneader/extruder may have any suitable L/D ratio, e.g. for the sake of example 15 to 50, and most preferably from 20 to 40.

The speed of the screws of the second co-rotating twin-screw continuous kneader/extruder should be between 50 and 1200 rpm, alternatively between 50 to 800, alternatively between 200 to 1200. The external surface of the barrel of the second co-rotating twin-screw continuous kneader/extruder should preferably be enclosed in a heater-equipped jacket in order to assist in maintaining keep the mixture in the barrel at a temperature of from 20 to 300, alternatively from 100 to 300° C., alternatively from 150 to 300° C., alternatively 150 to 250° C. again dependent on the mixing regime utilised.

The final silicone rubber base composition generated by this process can be utilised in a variety of ways. For example, it may be transported directly to a packaging unit and sold to customers as a silicone rubber base composition or masterbatch thereof for use in silicone rubber compounding operations, or alternatively be transported to one or more finishing type units. Such finishing units may be batch units or continuous finishing units. The finishing units are generally designed to make final compounded products for end use. In the case of liquid silicone rubber materials these are usually cured via an addition or hydrosilylation process. Addition or hydrosilylation curable compositions are usually stored in two (or more) parts to avoid premature cure during storage.

The silicone rubber base composition prepared using the process described herein may be used in the preparation of a part A composition and/or a part B composition for a two-part addition or hydrosilylation curable composition. Two-part addition or hydrosilylation curable compositions are referred to as having a part A composition and a part B composition. A part A composition comprises a silicone rubber base composition e.g. final silicone rubber base composition as described herein in combination with a hydrosilylation catalyst. A part B composition comprising a silicone rubber base composition e.g. final silicone rubber base composition as described herein in combination with cross-linker and optionally inhibitor. It is important to ensure that no cross-linker is present in Part A composition and no catalyst is present in the part B composition.

### FIGURE

An embodiment of the disclosure herein will now be described by way of example with reference to the accompanying FIG. 1 in which:

FIG. 1 is a schematic view of a process assembly for an embodiment of the disclosure as described herein.

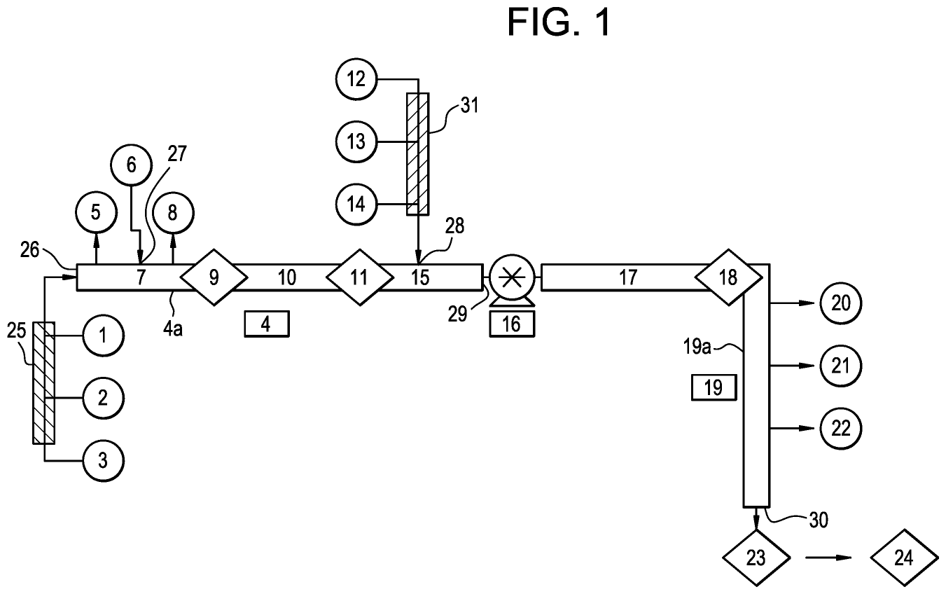

Referring to FIG. 1 there is provided a first static mixer (25), first co-rotating twin-screw extruder (4), a pump (16), a residence zone (17) and a means for vacuum stripping in the form of a second co-rotating twin-screw continuous extruder (19).

First co-rotating twin-screw extruder (4) comprises a starting material entry port (26), a reinforcing silica filler entry port (27), vents to the atmosphere (5) and (8), a pair of screws (not shown) a barrel (4a), an additional entry port (28) and a discharge port (29). The residence zone (17) is a combination of pipes and a further static mixer. The second co-rotating twin-screw continuous extruder (19) has an entry port (not shown) a pair of screws (not shown) a barrel (19a) and a discharge port (30). The second co-rotating twin-screw continuous extruder (19) also has several vents for vacuum stripping material being transported therethrough of which three are shown (20, 21 and 22).

There is also provided a first feed (3) for the one or more polyorganosiloxanes containing at least two unsaturated groups per molecule, typically alkenyl groups (component (A)), a first feed (1) for hydrophobing treating agent (component (C)), a first feed (2) for water (component (D)) if required, each of which, in use, is designed to feed their respective components into the first static mixer (25).

A reinforcing silica store (6) is provided to, in use, feed silica into first co-rotating twin-screw extruder (4), by way of entry port (27).

There is also provided a second feed (12) for the one or more polyorganosiloxanes containing at least two unsaturated groups per molecule, typically alkenyl groups (component (A), a second feed (14) for one or more hydrophobing treating agents (component (C)), a second feed (13) for water (component (D)) if required, each of which, in use, is designed to feed their respective components into second static mixer (31) which, in use, is provided to introduce the mixture resulting from second static mixer (31) on to first co-rotating twin-screw extruder (4), by way of entry port (28).

Feeds (3) and (14) utilised gear pumps (not shown) to introduce component (A) into the first and second static mixers (25, 31). Feeds (1) and (2) utilised syringe pumps or piston pumps (in the case of extruders with larger barrels to introduce components (C) and (D) respectively into the first static mixer (25). Feeds (14) and (13) utilised syringe pumps to introduce components (C) and (D) respectively into the second static mixer (31). Component (B) was introduced onto the first co-rotating twin-screw extruder (4), by way of a loss in weight screw feeder paired with a continuous side-feeder from store (6).

The external surface of the first co-rotating twin-screw extruder (4) is enclosed in a jacket (not shown) for heating and/or cooling to maintain the temperatures in the zones within the required ranges. In the case of cooling this may be achieved by e.g. circulating cooling water to reduce e.g. the friction-induced heating of the material in said first co-rotating twin-screw extruder (4).

In use, hydrophobing treating agent (C) in the form of hexamethyldisilazane, water (D) and a dimethylvinyl terminated polydimethylsiloxane polymer having a viscosity of 53,000 mPa·s at 25° C. are each separately introduced from feeds (1, 2 and 3) respectively, into a first static mixer (25) to form a step (a) mixture.

Upon leaving the first static mixer (25) the step (a) mixture is introduced into first twin-screw extruder 4 through entry port (26). The first twin-screw extruder (4) is a co-rotating and intermeshing twin-screw extruder having an elongate barrel (4a) which holds the twin screws (not shown) attached to a drive unit (not shown) designed to rotate both the screws at the same speed. The first twin-screw extruder (4) has an L/D ratio of 48. The speed of the screws of the first co-rotating twin-screw extruder are predetermined dependent on the system requirements but, solely for the sake of example, may be from between 200 and 1200 rpm.

The first zone (7) on the twin-screw extruder (4) is provided for step (b) of the process, the introduction of reinforcing filler (B) into the step (a) mixture, thereby wetting the surface of the reinforcing filler (B) with the step (a) mixture to form a viscous paste. Entry port (26) is provided for the introduction of the step (a) mixture described above. Entry port (27) is used to introduce the silica filler from supply store (6) into the step (a) mixture and any air trapped in the filler prior to or subsequent to the addition of the filler through entry port (27) is allowed to escape via atmospheric pressure vents (5) and (8). At the end of the first zone (9) of first twin screw extruder (4), a viscous paste resulting from the mixing of components (A), (B), (C) and (D) has been made.

The viscous paste is then transferred downstream to the second zone (10) of twin screw extruder (4) in which dispersive mixing and kneading is carried out to break down the reinforcing silica filler from agglomerates (particle size about 50-100 μm) to aggregates (particle size about 1-10 μm) and ultimately considerable fractions of the silica may comprise silica in the 50-500 nanometer range and provide a silica dispersion of the reinforcing filler (B) in the other components at the end of the second zone (11) along twin screw extruder (4) as a product of step (c).

Subsequently the resulting silica dispersion of step (c), is transferred to a third zone (15) for in this instance a step (f) dilution step between steps (c) and (d). In the third zone (15) in FIG. 1 components (C), (D) and (A) are supplied from feeds (14, 13 and 12) respectively into second static mixer (31). In an alternative route (not shown) there may be two additional entry ports a first for the introduction of a components (C) optionally in a mixture with component (D) and the second for the introduction of component (A).

The resulting diluted silica dispersion obtained in step (f) was then transported to the discharge port (29) and further through pump (16) which pumps the diluted silica dispersion into residence zone (17) which comprises pipes and a further static mixer for further mixing and filler treatment. The diluted silica dispersion resulting from step (f) is then mixed in the residence zone (17) for a period of from 5 to 30 minutes, alternatively 5 to 20 minutes, alternatively 10 to 20 minutes at a temperature of between 90 and 170° C. and a pressure of between 300 and 2,000 kPa.

At the end (18) of residence zone (17) the resulting product is an unstripped silicone rubber base composition which is introduced on to the means for vacuum stripping (19) which in these examples is a second co-rotating twin-screw continuous extruder (19). The second co-rotating twin-screw continuous extruder (19) is utilised to strip out residual treating agent, water, and ammonia, if present under heat and vacuum, through ports (20, 21 and 22) in order to produce a final silicone rubber base composition (23) which exits the second co-rotating twin-screw continuous extruder (19), via discharge port (30).

The second co-rotating twin-screw continuous kneader/extruder may have any suitable L/D ratio, e.g. for the sake of example 15 to 50, and alternatively from 20 to 40.

The speed of the screws of the second co-rotating twin-screw continuous kneader/extruder should be from 50-800 rpm. The external surface of the barrel of the second co-rotating twin-screw continuous kneader/extruder should preferably be enclosed in a heater-equipped jacket in order to assist in maintaining keep the mixture in the barrel at a temperature of from 150 to 300° C., alternatively 150 to 250° C. The pressure used is between 10 to 500 mbar (1 to 50 kPa), alternatively to 500 mbar (2 to 50 kPa), alternatively between 50 to 200 mbar (5 and 20 kPa).

The resulting silicone rubber base composition (23) may then be transported to packaging or for compounding/finishing (24) whichever is required. In the latter case, the silicone rubber base composition as described herein may be used in the preparation of a hydrosilylation cure silicone rubber composition. This may be in two parts one comprising a hydrosilylation cure catalyst and the other comprising a cross-linker.

As previously discussed the likes of temperature sensors for measuring the temperature of the mixture, flow rate sensors, pressure sensors and other instrumentation and/or sensors, and the like may be utilised during the process as and where required, although not shown. Likewise, as previously discussed, if desired, additives may be introduced into the mixture en route to the means for vacuum stripping.

The above explanation of the process described will now be exemplified using the following two examples which describe embodiments of the disclosure herein and are conducted in accordance with the depiction of FIG. 1 herein unless otherwise indicated.

### EXAMPLES

Unless otherwise indicated the viscosity measurements described are provided from a TA-Instruments AR2000Ex cone plate rheometer @ 10 s⁻¹ for viscosities of 1000 mPa·s and above or a Brookfield® rotational viscometer with spindle LV-1 (designed for viscosities in the range between −20,000 mPa·s) for viscosities less than 1000 mPa·s and adapting the shear rate according to the polymer viscosity e.g. 10 s⁻¹ or 100 s⁻¹. Unless otherwise indicated, all viscosity measurements were taken at 25° C.

### Example 1 (Ex. 1) and Comparative Example 1 (C. 1)

The compositions used in Ex. 1 and C. 1 are provided in Table 1 a.

TABLE 1a

| | C. 1 (wt. %) | Ex. 1 (wt. %) |
|---|---|---|
| Polymer 1 | 73.03 | 70.85 |
| Water | 0.96 | 2.24 |
| HMDZ | 2.82 | 4.41 |
| Silica 1 | 23.19 | 22.50 |

The polymer used, polymer 1, was a vinyldimethyl terminated polydimethylsiloxane having a viscosity of about 55,000 mPa·s; and Silica 1 was a fumed silica having a specific surface area of 258 g/m² (BET method in accordance with ISO 9277: 2010).

In Ex. 1 polymer, water and hexamethyldisilazane (HMDZ) were introduced in two parts. In each case they were introduced at a constant rate. The wt. % added for each ingredient together with the step during which it was introduced on to the first twin screw extruder are depicted in Table 1b.

TABLE 1b
amounts of each ingredient added at constant rate per step

| | Step when added | C. 1 (wt. %) | Ex. 1(wt. %) |
|---|---|---|---|
| Polymer 1 | (a) | 33.16 | 32.17 |
| Water | (a) | 0.96 | 0.93 |
| HMDZ | (a) | 2.82 | 2.73 |
| Silica | (b) | 23.19 | 22.50 |
| Water | (f) | 0.00 | 1.31 |
| HMDZ | (f) | 0.00 | 1.68 |
| Polymer | (f) | 39.87 | 38.68 |
| Total | | 100.00% | 100.00% |

In these examples the first twin-screw extruder (4) was a Werner-Pfleiderer co-rotating twin-screw extruder with a 25 mm diameter and an L/D ratio of 48. The screws were run at 700 rpm. The temperature of entry port (26) was approximately 20° C. and the temperature at the discharge port (29) of said first twin-screw extruder (4) was approximately 110° C. Feeds (1-3, and 6) were all operated at room temperature.

In step (a) components (C), (D) and (A) were introduced via feeds (1, 2 and 3) respectively into first static mixer (25) and after mixing therein produced a step (a) mixture which was transported into a Werner-Pfleiderer (now Coperion) co-rotating twin-screw extruder (4), through entry port (26).

In step (b) silica was introduced onto the Werner-Pfleiderer co-rotating twin-screw extruder 4 via entry port (27) from store (6) and mixed with the step (a) mixture to form the viscous paste. The viscous paste was broken down in step (c) as previously discussed and then in this instance instead of the arrangement described with respect to FIG. 1, there were two entry ports in the third zone (15) for introducing components onto the Werner-Pfleiderer co-rotating twin-screw extruder (4). A first entry port for a mixture of components (C) and (D) and a second entry port for introducing a second amount of component (A), in each case diluting the material in the extruder (4) such that the diluted silica dispersion obtained in step (f) was then transported to the discharge port (29).

The mixture exiting through discharge port (29) was then transported and pumped through residence zone (17), which comprised pipes and a static mixer. The temperature and pressure of the residence zone were 140° C. and 50 psi (344.74 kPa) and the material had an average residence time in residence zone (17) of about 13 minutes.

The means for vacuum stripping (19) utilised in example 1 was a Welding Engineers Model 0.8″ (2.032 cm) twin-screw devolatilizing extruder. It was non-intermeshing and counter rotating. Material travelling through Welding Engineers Model 0.8″ twin-screw devolatilizing extruder (19) was stripped (devolatilized) at 190° C.

The viscosity of the silicone rubber base compositions for Ex. 1 and C. 1 were determined using a TA Instruments AR 2000 parallel plate rheometer at 25° C. at a frequency of 0.1 s⁻¹. It was found that the viscosity for Ex. 1 having HMDZ and water introduced during step (f) had significantly better (lower) viscosity result (787 Pa·s) than did C. 1 which had no additional HMDZ or water added during step (f) resulting in a viscosity of 3198 Pa·s).

### Examples 2 and 3

In Ex. 2 and 3 identical compositions were prepared into base compositions using exactly the same equipment and process as described in Ex.1 and C. 1 above with the following exceptions
(i) silica (ii) was used which was a fumed silica having a specific surface area of 248 g/m² (BET method in accordance with ISO 9277: 2010);
(ii) Ex. 2 the temperature used in the residence zone was 90° C.; and
(iii) Ex. 3 the temperature used in the residence zone was 170° C.

The composition used for both Ex. 2 and Ex. 3 is depicted in Table 2a.

TABLE 2a

| | Ex. 2 & Ex. 3 (wt. %) |
|---|---|
| Polymer 1 | 67.88 |
| Water | 2.32 |
| HMDZ | 5.10 |
| Silica (ii) | 24.70 |

TABLE 2b

| | Step when added | Ex. 2 & Ex. 3 (wt. %) |
|---|---|---|
| Polymer 1 | (a) | 33.94 |
| Water | (a) | 0.93 |
| HMDZ | (a) | 4.63 |
| Silica (ii) | (b) | 24.70 |
| Water | (f) | 1.39 |
| HMDZ | (f) | 0.46 |
| Polymer | (f) | 33.94 |
| Total | | 100.00% |

The viscosity of the silicone rubber base compositions for Ex. 2 and Ex. 3 were determined using the method described above. The viscosity of Ex. 2 was 1909 Pa·s and for Ex. 3 was 1222 Pa·s. It is considered that both provided base compositions as herein before described but that the base composition of Ex. 3 gave better results as the viscosity was lower indicating an improved filler treatment.

The base composition of Ex. 3 was then used to prepare a curable two-part silicone rubber composition wherein the base of Ex. 3 was mixed with a platinum-based catalyst to form a part A composition, wherein the platinum-based catalyst was present in the part A composition in an amount of 0.33 wt. %. A part B composition was prepared by mixing the base of Ex. 3 with a cross-linker in the form of trimethyl terminated dimethylmethylhydrogen polysiloxane having a viscosity of 45 mPa·s at 25° C. in an amount of 1.6 wt. % of the part B composition and inhibitor in an amount of 0.095 wt. % of the part B composition. The part A and part B compositions were then mixed together, and the final composition was cured at a temperature of 150° C. for a period of 5 minutes, followed by a 4 hour, 200° C. post cure.

Once cured the physical properties of the resulting elastomer was determined and was compared with the physical properties of a reference elastomer made with an identical list of ingredients using a standard batch technique. The comparison of the physical properties between Ex. 3 and the ref elastomer are depicted in Table 2c below.

TABLE 2c

| | Ex. 3 | Ref. |
|---|---|---|
| Shore A Durometer (ASTM D2240-97) | 33.4 | 30.6 |
| Tensile Strength (MPa)_ASTM D412-98A | 7.53 | 8.03 |
| Elongation ASTM D412-98A | 651 | 737 |
| Tear Strength (N/mm) ASTM D624 (Die B) | 24.69 | 15.24 |

It can be seen that the results are similar indicating that the process used as described herein results in similarly treated filler when make silicone bases from a continuous process herein and a standard batch process.

### Example 4

In this example the base composition was prepared using a 40 mm screw and piston pumps were utilised as appropriate. The composition used is depicted in Table 3a.

TABLE 3a

| | Ex. 4 (wt. %) |
|---|---|
| Polymer 1 | 69.57 |
| Water | 2.41 |
| HMDZ | 5.93 |
| Silica 1 | 22.09 |

Polymer 1 and silica 1 were the same as used in Ex. 1 and C. 1 above. In Ex. 4 polymer, water and hexamethyldisilazane (HMDZ) were introduced in two parts. In each case they were introduced at a constant rate. The wt. % added for each ingredient together with the step during which it was introduced on to the first twin screw extruder are depicted in Table 3b.

TABLE 3b

| | Step when added | Ex. 4(wt. %) |
|---|---|---|
| Polymer 1 | (a) | 28.05 |
| Water 1 | (a) | 0.80 |
| HMDZ 1 | (a) | 3.58 |
| Silica | (b) | 22.09 |
| Water 2 | (f) | 1.61 |
| HMDZ 2 | (f) | 2.35 |
| Polymer 2 | (f) | 41.52 |
| Total | | 100.00% |

Again referring to FIG. 1, in Ex. 4 the first twin-screw extruder (4) was a ZSK 40 McPlus co-rotating twin-screw extruder from Coperion with a 40 mm diameter and an L/D ratio of 62. The screws were run at 700 rpm and the temperature at the discharge port (29) of said first twin-screw extruder (4) was 110° C.

Feeds (1-3, and 6) were all operated at room temperature. In step (a) components (C), (D) and (A) were introduced via feeds (1, 2 and 3) respectively into first static mixer (25) and after mixing therein produced a step (a) mixture which was transported into the ZSK 40 McPlus co-rotating twin-screw extruder (4) through entry port (26).

In step (b) of example 4 silica was introduced onto the ZSK 40 McPlus co-rotating twin-screw extruder (4) via entry port (27) from store (6) and mixed with the step (a) mixture to form the viscous paste. The viscous paste was broken down in step (c) as previously discussed and then in this instance like in Example 1 instead of the arrangement described with respect to FIG. 1, there were three entry ports in the third zone (15) for introducing ingredients onto the ZSK 40 McPlus co-rotating twin-screw extruder (4). A first entry port for (C) a second entry port for component and a third additional entry port was for introducing a second amount of component (A). Components (C) and (D) were introduced at room temperature.

The mixture exiting through discharge port (29) was then transported and pumped through residence zone (17), which comprised pipes and a static mixer. The temperature and pressure of the residence zone were 140° C. and 145 psi (999.74 kPa) and the material had an average residence time in residence zone (17) of about 18 minutes.

The second extruder (19) was a ZSK 32 McPlus co-rotating twin-screw devolatilizing extruder from Coperion. Material travelling through said ZSK 32 McPlus co-rotating twin-screw devolatilizing extruder (19) was stripped (devolatilized) at 160° C.

The viscosity of the silicone rubber base composition for Ex. 4 were determined using the same test methodology as described for Ex. 1 and C. 1 and the viscosity was determined to be 4094 Pa·s.

1. A continuous method for the preparation of a silicone rubber base composition, the composition comprising:
(A) one or more polyorganosiloxanes containing at least two unsaturated groups per molecule selected from alkenyl groups and alkynyl groups, and
(B′) a hydrophobically treated reinforcing silica filler; said method comprising the steps of:
(a) introducing (C) at least one hydrophobing treating agent, and component (A), and optionally (D) water, into a first static mixer (25) to form a step (a) mixture and then introducing the step (a) mixture on to a first twin-screw extruder (4);
(b) introducing (B) reinforcing silica filler into the step (a) mixture via a reinforcing silica filler (B) entry port (27) in the first twin-screw extruder (4) while maintaining the temperature in a range of between 20 to 80° C. to form a viscous paste and providing at least one vent (5, 8) to the atmosphere up and/or downstream of the reinforcing silica filler (B) entry port (27) to allow gases present to escape;
(c) mixing the viscous paste resulting from step (b) in a dispersive mixing and kneading zone in the first twin-screw extruder (4) to form a silica dispersion;
(d) further mixing the silica dispersion produced in step (c) in a residence zone (17) downstream of the first twin-screw extruder (4) to provide an unstripped silicone rubber base composition;
(e) stripping the unstripped silicone rubber base composition with vacuum stripping to provide a silicone rubber base composition at a temperature of at least 100° C.; and
(f) introducing component (C) and optionally one or both of components (A) and (D) either into the first twin-screw extruder (4) between steps (c) and (d) and/or during step (d) to dilute and further hydrophobically treat silica from the silica dispersion of step (c) and subsequently form a diluted silica dispersion.

2. The continuous method for the preparation of a silicone rubber base composition in accordance with claim 1, wherein components and component (D) when present are introduced into the first static mixer (25) at pre-defined controlled rates which may be varied relative to each other within a pre-determined range as and when required.

3. The continuous method for the preparation of a silicone rubber base composition in accordance with claim 1, wherein components (C) and (A), and optionally component (D), are pumped into the first static mixer (25) by one or more weight loss meters, mass flow meters, gear pumps, syringe pumps, or piston pumps, or a combination thereof.

4. The continuous method for the preparation of a silicone rubber base composition in accordance with claim 1, wherein:
(i) component (A) comprises one or more polydiorganosiloxanes containing at least two alkenyl groups per molecule and optionally a polyorganosiloxane resin containing at least two alkenyl groups per molecule; and/or
(ii) additives are introduced into the mixture during the preparation.

5. The continuous method for the preparation of a silicone rubber base composition in accordance with claim 1, wherein the first twin-screw extruder (4) is a co-rotating twin-screw extruder, an intermeshing twin-screw extruder or a co-rotating and intermeshing twin-screw extruder.

6. The continuous method for the preparation of a silicone rubber base composition in accordance with claim 1, wherein the first twin-screw extruder (4) has an axial length LL to screw diameter (D) ratio of from 25:1 to 65:1.

7. The continuous method for the preparation of a silicone rubber base composition in accordance with claim 1, wherein component (B) is fed to the reinforcing filler (B) entry port (27) at a constant rate by a continuous feeder for powder selected from one or more tables, belts, loss in weight feeders, side feeders, feed enhancement technology systems, or screws.

8. The continuous method for the preparation of a silicone rubber base composition in accordance with claim 1, wherein in step (f) there is provided first and second additional entry ports (28), and wherein the first additional entry port is utilized for the introduction of additional amounts of component (C) and optionally component (D) and the second additional entry port is utilized for the introduction of additional amounts of component (A).

9. The continuous method for the preparation of a silicone rubber base composition in accordance with claim wherein component (C), and component (D) when present, is/are pre-mixed in a second static mixer (31) prior to being introduced through the first additional entry port (28).

10. The continuous method for the preparation of a silicone rubber base composition in accordance with claim 1, wherein the further mixing in step (e) is carried out in a residence zone (17) optionally comprising a third static mixer.

11. The continuous method for the preparation of a silicone rubber base composition in accordance with claim Mc wherein residence zone (17) is controlled at a pressure of between 300 and 2,000_kPa and at a temperature of between 90 and 170° C. and wherein the average residence time in the residence zone (17) is from 5 to 30 minutes.

12. The continuous method for the preparation of a silicone rubber base composition in accordance with claim 1, wherein step (e) is undertaken in a continuous stripping device (19), designed to vacuum strip volatiles and gases from the unstripped silicone rubber base composition resulting from step (d).

13. The continuous method for the preparation of a silicone rubber base composition in accordance with claim 1, wherein one or more temperature sensors, flow rate sensors, pressure sensors and other instrumentation and/or sensors, are utilized during the method.

14. A silicone rubber base composition manufacturing assembly adapted to make a silicone rubber base composition by the continuous method in accordance with claim 1.

15. A silicone rubber base composition obtainable or obtained by the continuous method in accordance with claim 1.

16. A hydrosilylation cure silicone rubber composition comprising the silicone rubber base composition in accordance with claim 15.
